(19) United States
(12) Patent Application Publication
(10) Pub. No.: US 2017/0003434 A1
(43) Pub. Date: Jan. 5, 2017

(54) BACKLIGHT MODULE AND LIQUID CRYSTAL DISPLAY

(71) Applicant: Chunghwa Picture Tubes, Ltd., Taoyuan City (TW)

(72) Inventors: Chun-Chang Yang, Hsinchu City (TW); Lun-Wei Kang, Taoyuan City (TW); Ching-Lung Chang, Taoyuan City (TW)

(21) Appl. No.: 14/831,883

(22) Filed: Aug. 21, 2015

(30) Foreign Application Priority Data
Jun. 30, 2015 (CN) 201510385540.0

(51) Int. Cl. F21V 8/00

(52) U.S. Cl. CPC G02B 6/0045; G02B 6/0088; G02B 6/0055

(57) ABSTRACT

A backlight module includes a light guide plate, a light source and a plastic frame. The light guide plate includes a light emitting surface, a bottom surface, a light incident surface and a first side surface. The first side surface includes a first inclined surface only. A first angle is between the first inclined surface and the bottom surface, and the first angle is an acute angle. The light source emits a light into the light guide plate through the light incident surface. The plastic frame includes a first portion disposed facing to the first side surface, wherein a portion of the light exits the light guide plate through the first side surface, and the portion of the light is reflected back to the first side surface by the first portion and then being refracted to the bottom surface through the first side surface.

### BACKGROUND OF THE INVENTION

1. Field of the Invention

The present invention generally relates to a backlight module and a liquid crystal display, and more particularly, to a backlight module and a liquid crystal display including a light guide plate having an inclined surface.

2. Description of the Prior Art

With the improvement in liquid crystal display (LCD) technique, liquid crystal display has been prevalently used in electronic products such as flat panel televisions, laptop computers, and smart phones. Generally speaking, the liquid crystal display requires a backlight module to provide light for displaying since the liquid crystal display panel is a non-self-luminous display panel. In a conventional backlight module, a side surface of a light guide plate is disposed perpendicular to a bottom surface of the light guide plate. In addition, light coming from the outside of the light guide plate is refracted through the side surface of the light guide plate to the bottom surface of the light guide plate, and the position where light strikes the bottom surface is at a distance from the side surface. Therefore, light emitted by a peripheral region of the backlight module which is adjoining to the side surface of the light guide plate is less than other regions of the backlight module. As a result, the conventional backlight module encounters the issue of the poor light uniformity in the peripheral region of the backlight module, which further degrades the display quality in the peripheral region of the liquid crystal display.

### SUMMARY OF THE INVENTION

One of the objectives of the present invention is to provide a backlight module and a liquid crystal display including a light guide plate having an inclined surface to enhance the light uniformity of the backlight module and the display uniformity of the liquid crystal display, to overcome the issue of the poor light uniformity in the peripheral region of the conventional backlight module, and to overcome the poor display quality in the peripheral region of the liquid crystal display.

To achieve the purposes described above, an embodiment of the present invention provides a backlight module. The backlight module includes a light guide plate, a light source and a plastic frame. The light guide plate includes a light emitting surface, a bottom surface, a light incident surface and a first side surface. The bottom surface is disposed opposite to the light emitting surface. The light incident surface is disposed between the light emitting surface and the bottom surface and is respectively connected to the light emitting surface and the bottom surface. The first side surface is disposed opposite to the light incident surface and is respectively connected to the light emitting surface and the bottom surface, wherein the first side surface consists of a first inclined surface, a first angle is between the first inclined surface and the bottom surface, and the first angle is an acute angle. The light source faces the light incident surface for emitting a light, wherein the light enters into the light guide plate through the light incident surface. The plastic frame includes a first portion facing the first side surface, wherein a portion of the light exits the light guide plate through the first side surface, and the portion of the light is reflected back to the first side surface by the first portion, and the light is refracted through the first side surface to the bottom surface.

To achieve the purposes described above, another embodiment of the present invention provides a liquid crystal display. The liquid crystal display includes the aforementioned backlight module and a liquid crystal display panel, and the liquid crystal display panel is disposed on the light emitting surface of the light guide plate.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating a top view of a backlight module according to a first embodiment of the present invention.

FIG. 2 is a schematic diagram illustrating a cross-sectional view of the backlight module taken along a line A-A′ in FIG. 1.

FIG. 3 is a schematic diagram illustrating a cross-sectional view of the backlight module taken along a line B-B′ in FIG. 1.

FIG. 4 is a schematic diagram illustrating an optical path of the backlight module according to a first embodiment of the present invention.

FIG. 5 is a schematic diagram illustrating a simulation result of the backlight module according to a first embodiment of the present invention.

FIG. 6 is a schematic diagram illustrating a top view of a backlight module according to a second embodiment of the present invention.

FIG. 7 is a schematic diagram illustrating a cross-sectional view of the backlight module taken along a line C-C′ in FIG. 6.

FIG. 8 is a schematic diagram illustrating a cross-sectional view of the backlight module taken along a line D-D′ in FIG. 6.

FIG. 9 is a schematic diagram illustrating a cross-sectional view of a liquid crystal display according to an embodiment of the present invention.

### DETAILED DESCRIPTION

To provide a better understanding of the present invention to the skilled users in the technology of the present invention, preferred embodiments will be detailed as follows. The preferred embodiments of the present invention are illustrated in the accompanying drawings with numbered elements to elaborate the contents and effects to be achieved.

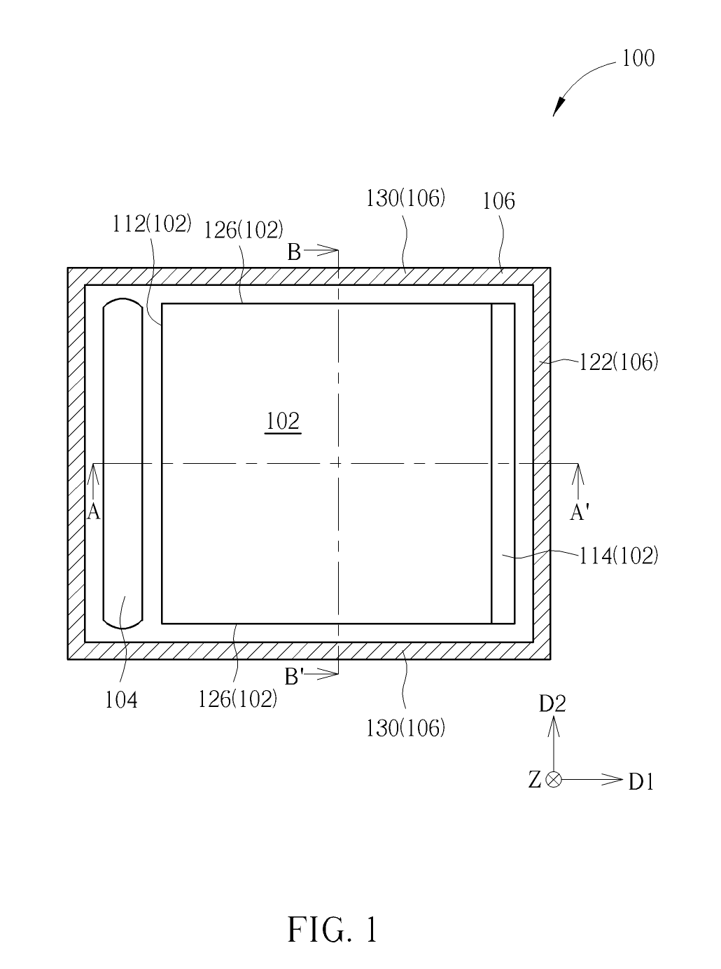

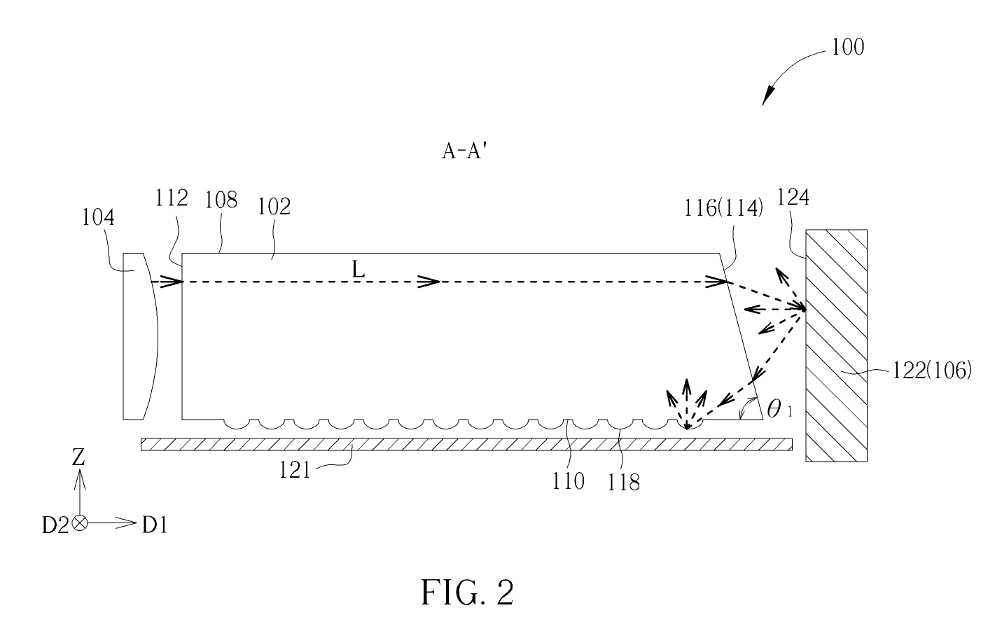

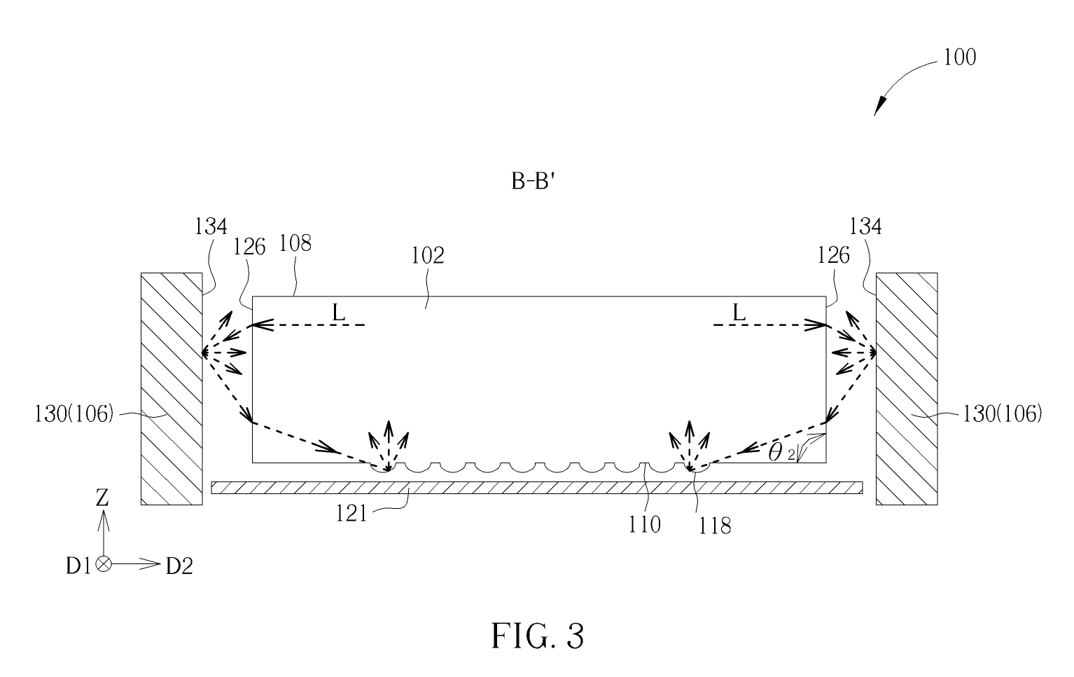

Please refer to FIGS. 1-3. FIG. 1 is a schematic diagram illustrating a top view of a backlight module according to a first embodiment of the present invention, FIG. 2 is a schematic diagram illustrating a cross-sectional view of the backlight module taken along a line A-A′ in FIG. 1, and FIG. 3 is a schematic diagram illustrating a cross-sectional view of the backlight module taken along a line B-B′ in FIG. 1. As shown in FIGS. 1-3, a backlight module 100 of this embodiment includes a light guide plate (LGP) 102, a light source 104 and a plastic frame 106. The material of the light guide plate 102 may be a material having good transmittance, such as polymethylmethacrylate (PMMA) or other materials having good transmittance, but not limited thereto. The light guide plate 102 includes a light emitting surface 108, a bottom surface 110, a light incident surface 112 and a first side surface 114. The light emitting surface 108 is disposed opposite to the bottom surface 110 and substantially overlaps the bottom surface 110 in a vertical projection direction Z, the light incident surface 112 is disposed between the light emitting surface 108 and the bottom surface 110 and is respectively connected to the light emitting surface 108 and the bottom surface 110, and the first side surface 114 is disposed opposite to the light incident surface 112 in a first direction D1 and is respectively connected to the light emitting surface 108 and the bottom surface 110. Specifically, the light emitting surface 108 of this embodiment is a surface (a top surface) of the light guide plate 102 in the vertical projection direction Z, the bottom surface 110 is another surface of the light guide plate 102 in the vertical projection direction Z, the light incident surface 112 is a side surface of the light guide plate 102 in the first direction D1, and the first side surface 114 is another surface of the light guide plate in the first direction D1. The first side surface 114 consists of a first inclined surface 116. In addition, a first angle θ₁ is between the first inclined surface 116 and the bottom surface 110, and the first angle θ₁ is an acute angle. In this embodiment, the length of the bottom surface 110 in the first direction D1 may be greater than the length of the light emitting surface 108, and the area of the bottom surface 110 may be greater than the area of the light emitting surface 108, but not limited thereto. What's more, the light guide plate 102 further includes two opposite second side surfaces 126 in a second direction D2. Each of the second side surfaces 126 is respectively connected to the light emitting surface 108 and the bottom surface 110 in the vertical projection direction Z, and each of the second side surfaces 126 is disposed between the light incident surface 112 and the first side surface 114 in the first direction D1. A second angle θ₂ is between the second side surface 126 and the bottom surface 110 of the light guide plate 102 of this embodiment. The second angle θ₂ may be a right angle, and the second side surface 126 may be perpendicular to the bottom surface 110. In addition, each of the second side surfaces 126 faces the plastic frame 106. In this embodiment, the light guide plate 102 further includes a plurality of micro structures 118 (as shown in FIG. 2 and FIG. 3) disposed on the bottom surface 110. The micro structures 118 may be uniform or non-uniform convex-concave patterns, such as circles, ellipses or other irregular shaped patterns. The micro structures 118 can avoid the total internal reflection which is occurred at the bottom surface 110, and therefore the refracted light can be emitted out from the light emitting surface 108 after the refracted light is reflected or dispersed by the micro structures 118 of the bottom surface 110.

In this embodiment, the light source 104 is disposed adjoining to the light guide plate 102, and the light source 104 faces the light incident surface 112 of the light guide plate 102. The light source 104 of this embodiment is an edge-type light source, and the light-emitting element of the light source 104 may be a cold cathode fluorescent lamp (CCFL), an external electrode fluorescent lamp (EEFL), a light emitting diode (LED) or other types of light-emitting elements. In this embodiment, the plastic frame 106 may be disposed along the edge of the backlight module 100, and the color of the plastic frame 106 may preferably be alight color for reducing the absorption of the light L. In addition, the color of the plastic frame 106 of this embodiment is white, but not limited thereto. In this embodiment, the plastic frame 106 includes a first portion 122 and a second portion 130. The first portion 122 faces the first side surface 114 of the light guide plate 102, and the first portion 122 has a reflecting surface 124 facing the first side surface 114 of the light guide plate 102. The second portion 130 faces the second side surface 126 of the light guide plate 102, and the second portion 130 has a reflecting surface 134 facing the second side surface 126 of the light guide plate 102. The reflecting surfaces 124, 134 of the first portion 122 and the second portion 130 may further include the micro structures or the surface treatments to provide the effect of the diffuse reflection to the light. What's more, the backlight module 100 of this embodiment further includes a reflector 121, the reflector 121 is disposed under the bottom surface 110 of the light guide plate 102 so as to reflect the light L to the light emitting surface 108 of the light guide plate 102. The material of the reflector 121 may be a reflective material such as metal, but not limited thereto.

As shown in FIG. 2, a light L emitted by the light source 104 enters into the light guide plate 102 through the light incident surface 112, and the light L travels in the light guide plate 102. A portion of the light L enters into the light guide plate 102 through the light incident surface 112, the portion of the light L then travels to the first side surface 114, and the portion of the light L exits the light guide plate 102 through the first side surface 114 and travels to the first portion 122 of the plastic frame 106. Specifically, the light L exiting the light guide plate 102 through the first side surface 114 is transmitted to the reflecting surface 124 of the first portion 122 of the plastic frame 106. Next, the reflecting surface 124 reflects the light L back to the first side surface 114 and the light L enters into the light guide plate 102 again through the first side surface 144. In addition, a portion of the light L enters into the light guide plate 102 through the first side surface 114, the portion of the light L is then directed to the light emitting surface 108 by the micro structures 118 of the bottom surface 110 and exits the light guide plate 102 through the light emitting surface 108. As shown in FIG. 3, the other portion of the light L enters the light guide plate 102 through the light incident surface 112, the other portion of the light L then travels to the second side surface 126 and exits the light guide plate 102 through the second side surface 126 and then travels to the plastic frame 106. Next, the plastic frame 106 reflects the light L back to the second side surface 126, and the light L enters into the light guide plate 102 again through the second side surface 126. A portion of the light L enters into the light guide plate 102 through the second side surface 126, the portion of the light L is then directed to the light emitting surface 108 by the micro structures 118 of the bottom surface 110 and exits the light guide plate 102 through the light emitting surface 108. It is noteworthy that the first angle θ₁ is between the first side surface 114 and the bottom surface 110 of the light guide plate 102 of this embodiment, and the first angle θ₁ is an acute angle. Therefore in this embodiment, the light L reflected by the reflecting surface 124 is refracted through the first side surface 114 into the light guide plate 102, and the position where the light L strikes the bottom surface 110 of the light guide plate 102 is closer to the first side surface 114 comparing to the light guide plate having the bottom surface 110 being perpendicular to the first side surface 114. As a result, the uniformity of the light provided by the backlight module 100 can be enhanced, the micro structures 118 disposed adjoining to the first side surface 114 can be utilized, and the issue of the poor light uniformity in the peripheral region of the conventional backlight module can be solved.

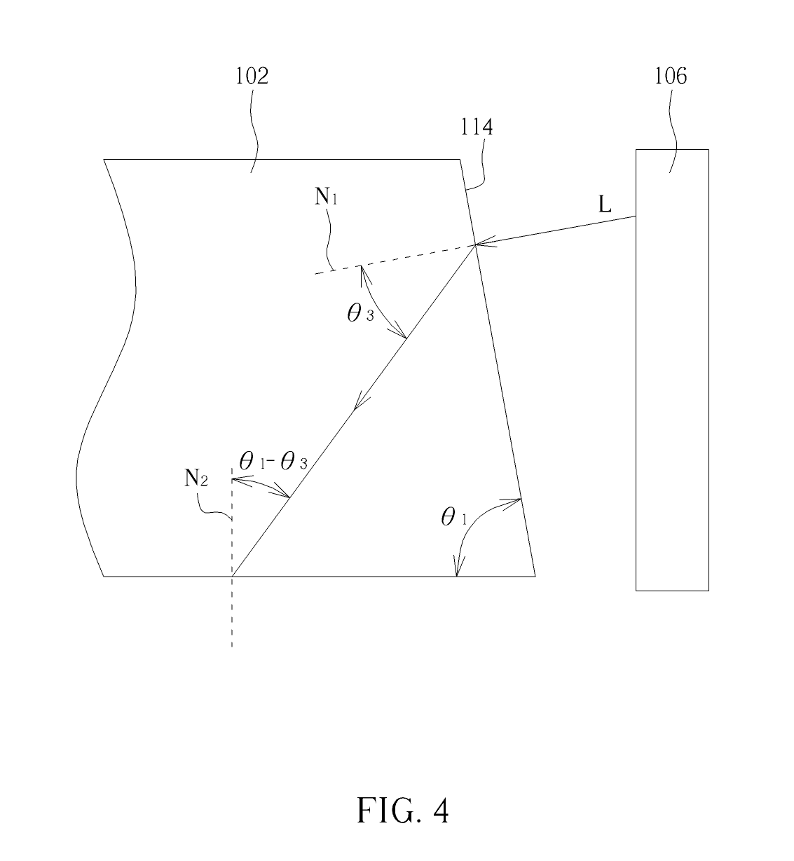

Please refer to FIG. 4. FIG. 4 is a schematic diagram illustrating an optical path of the backlight module according to a first embodiment of the present invention. In this embodiment, a third angle θ₃ is between a normal line N₁ of the first side surface 114 and the light L refracted into the light guide plate 102 through the first side surface 114. In addition, θ₁-θ₃ represents an angle between a normal line N₂ of the bottom surface 110 and the light L refracted into the light guide plate 102 through the first side surface 114. What's more, the light L reflected by the plastic frame 106 is refracted into the light guide plate 102 through the first side surface 114. When the light L cannot satisfy the condition of the total internal reflection in the bottom surface 110 of the light guide plate 102, the light L will refract through the bottom surface 110 again and will exit the light guide plate 102. As a result, the additional loss of the light L further reduces the utilization of the light L in the backlight module 100. To prevent the aforementioned situation, the third angle θ₃ is required to satisfy the condition of the total internal reflection, and the following formula (1) can be obtained by the Snell's law:

$${θ}_{1} - {θ}_{3} > {sin}^{- 1} ( \frac{{n}_{1}}{{n}_{2}} ) \qquad ( 1 )$$

where n₁ represents a refractive index of a medium outside the light guide plate 102, and n₂ represents a refractive index of the light guide plate 102. In addition, the light L is assumed to enter the light guide plate 102 perpendicularly, and the third angle θ₃ substantially satisfies the following formula (2):

$${θ}_{3} ≅ {sin}^{- 1} ( \frac{{n}_{1}}{{n}_{2}} ) \qquad ( 2 )$$

the following formula (3) can be obtained by the formula (1), (2) together, and the first angle θ₁ of this embodiment is substantially satisfied the formula (3):

$$2 {sin}^{- 1} ( \frac{{n}_{1}}{{n}_{2}} ) - α < {θ}_{1} < \frac{π}{2} \qquad ( 3 )$$

where α is an estimated value of the deviation caused during the fabrication or the assembling of the backlight module 100. α may be 5° in this embodiment, but not limited thereto. In this embodiment, the medium outside the light guide plate 102 is air, and the refractive index n₁ is 1. The material of the light guide plate 102 is polymethylmethacrylate (PMMA), and the refractive index n₂ is 1.49. According to the formula (3), the first angle θ₁ is greater than 79.3 and less than 90°, and therefore the first angle θ₁ of the light guide plate 102 can be prevented from being too small to cause the light L to be refracted through the bottom surface 110 to the outside of the light guide plate 102. The additional loss of the light L can also be prevented, and the utilization of the light L in the backlight module 100 can be enhanced.

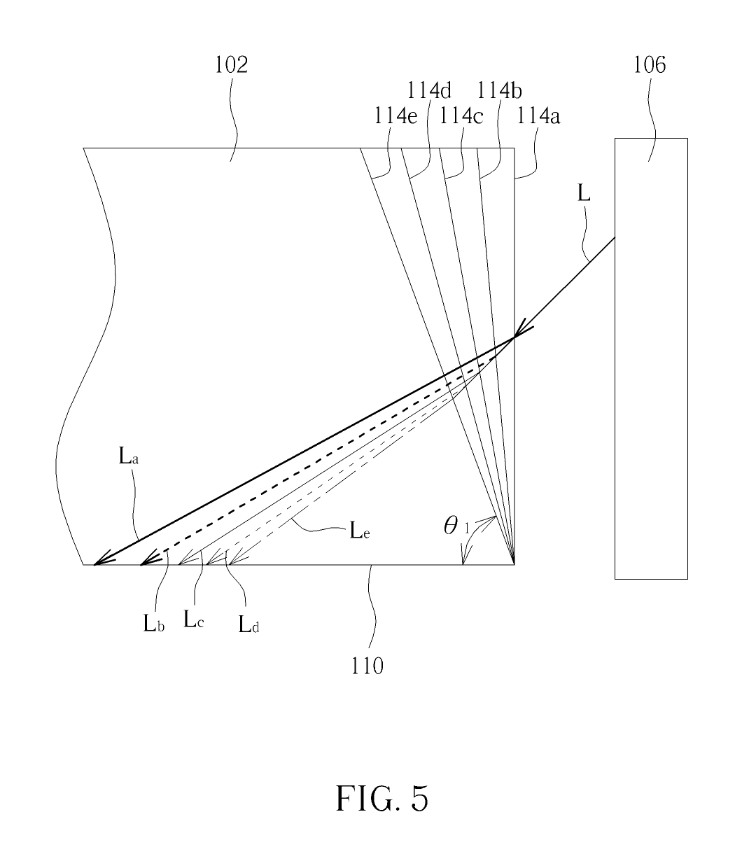

Please refer to FIG.5, and also refer to FIG. 2 together. FIG. 5 is a schematic diagram illustrating a simulation result of the backlight module according to a first embodiment of the present invention. In this embodiment, the light L is reflected by the plastic frame 106 and is refracted through the first side surface 114 to the bottom surface 110. A simulation is performed to simulate the position where the light L strikes the bottom surface 110 after being refracted through the first side surface 114. The first angle θ₁ of the light guide plate 102 in the simulation is 70°, 75°, 80°, 85° and 90° respectively. The medium outside the light guide plate 102 is air, and the refractive index of air is 1. The material of the light guide plate 102 is polymethylmethacrylate (PMMA), and the refractive index of polymethylmethacrylate is 1.49. As shown in FIG. 5, a first angle θ₁ between a first side surface 114a and the bottom surface 110 is 90°, and the light L becomes a refracted light La after being refracted through the first side surface 114a. A first angle θ₁ between a first side surface 114b and the bottom surface 110 is 85°, and the light L becomes a refracted light Lb after being refracted through the first side surface 114b. A first angle θ₁ between a first side surface 114c and the bottom surface 110 is 80°, and the light L becomes a light Lc after being refracted through the first side surface 114c. A first angle θ₁ between a first side surface 114d and the bottom surface is 75°, and the light L becomes a refracted light Ld after being refracted through the first side surface 114d. A first angle θ₁ between a first side surface 114e and the bottom surface 110 is 70°, and the light L becomes a refracted light Le after being refracted through the first side surface 114e. According to the result of the simulation shown in FIG. 5, the light L reflected by the plastic frame 106 is refracted into the light guide plate 102 through the first side surface 114, and the positions where the refracted lights La-Le strike the bottom surface 110 become closer to the first side surface 114 as the first angle θ₁ becomes smaller. Therefore, the light L is reflected by the reflecting surface 124 is refracted into the light guide plate 102 through the first side surface 114, and when the first angle θ₁ satisfies the formula (3), the position where the light L strikes the bottom surface 110 is closer to the first side surface 114 comparing to the light guide plate having the bottom surface 110 being perpendicular to the first side surface 114. In addition, the position where the light L strikes the bottom surface 110 becomes closer to the first side surface 114 as the first angle θ₁ becomes smaller. Thus, the uniformity of the light provided by the backlight module 100 can be enhanced, the micro structures 118 disposed adjoining to the first side surface 114 can be utilized, and the issue of the poor light uniformity in the peripheral region of the conventional backlight module can be solved.

The backlight module of the present invention is not limited to the above mentioned embodiment. The following description will detail the backlight modules of other preferable embodiments. To simplify the description, identical components in each of the following embodiments are marked with identical symbols. For making it easier to understand the differences between the embodiments, the following description will detail the dissimilarities among different embodiments and the identical features will not be redundantly described.

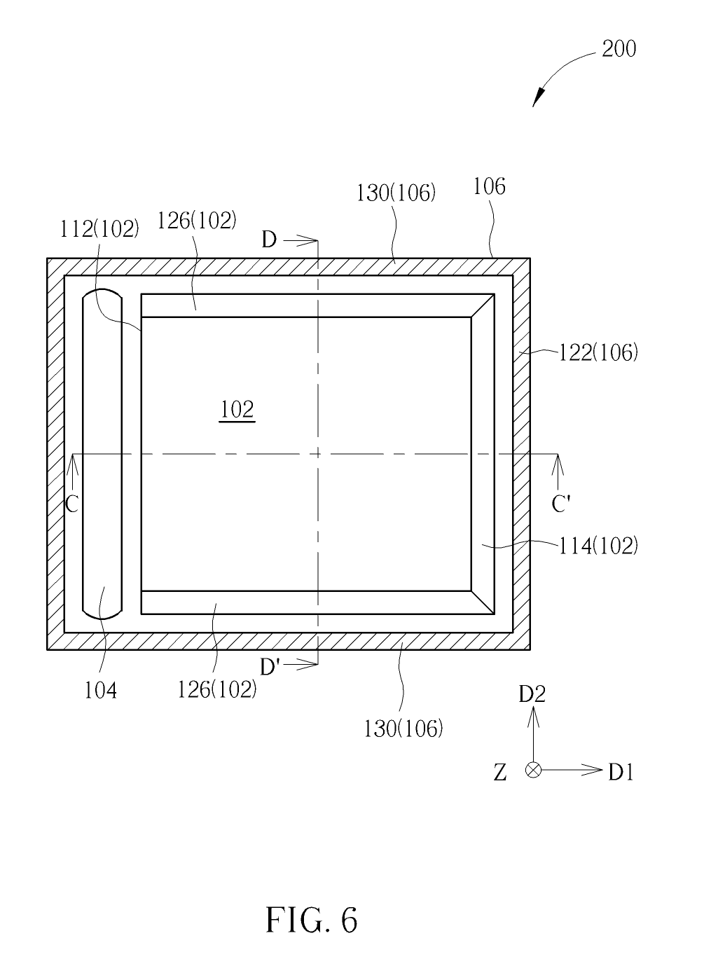

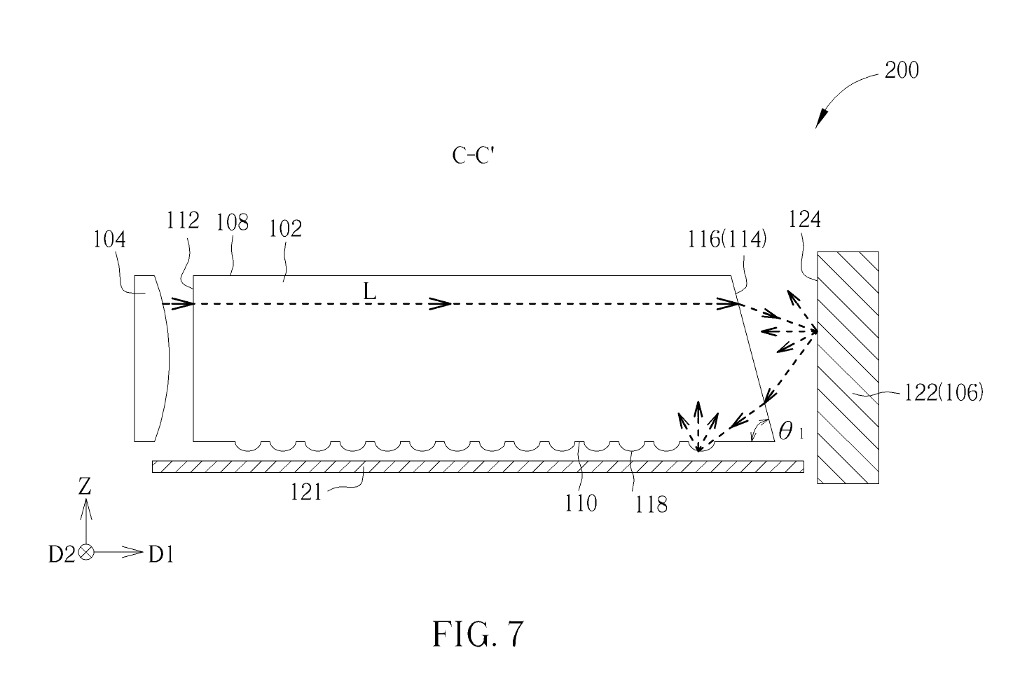

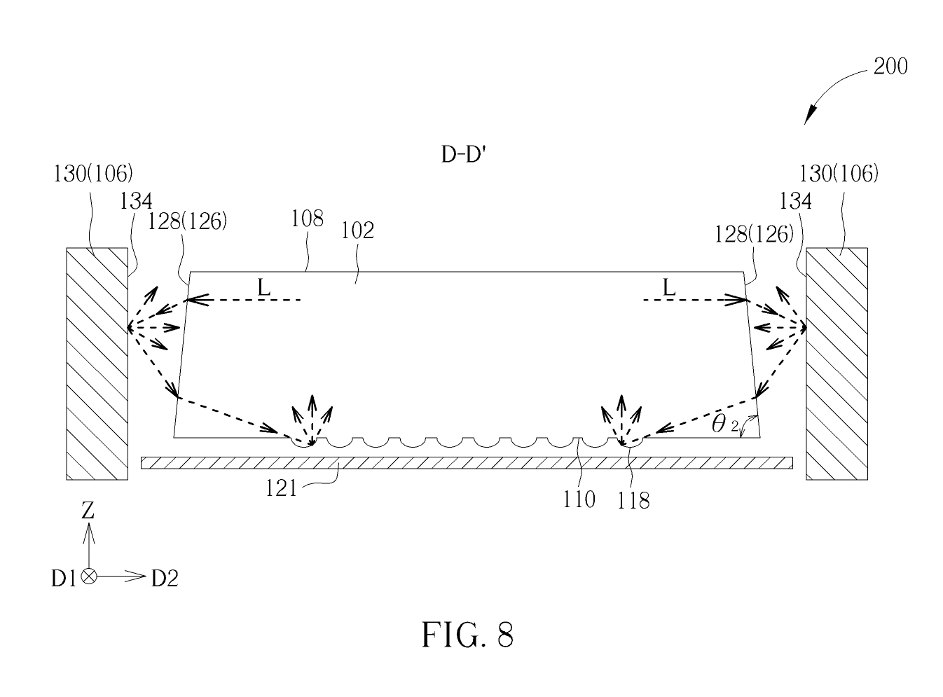

Please refer to FIGS. 6-8. FIG. 6 is a schematic diagram illustrating a top view of a backlight module according to a second embodiment of the present invention, FIG. 7 is a schematic diagram illustrating a cross-sectional view of the backlight module taken along a line C-C′ in FIG. 6, and FIG. 8 is a schematic diagram illustrating a cross-sectional view of the backlight module taken along a line D-D′ in FIG. 6. As shown in FIGS. 6-8, the difference between this embodiment and the first embodiment is that the second side surface 126 of this embodiment has a second inclined surface 128, a second angle θ₂ is between the second inclined surface 128 and the bottom surface 110, and the second angle θ₂ is an acute angle. In this embodiment, the length of the bottom surface 110 in the second direction D2 may be greater than the length of the light emitting surface 108, and the area of the bottom surface 110 may be greater than the area of the light emitting surface 108, but not limited thereto. It is noteworthy that the light guide plate 102 of this embodiment includes two opposite second side surfaces 126, one of the second side surfaces 126 is a side surface of the light guide plate 102 in the second direction D2, and the other one of the second side surfaces 126 is the other side surface of the light guide plate 102 in the second direction D2, and both of the second side surfaces 126 have the second inclined surfaces 128, but not limited thereto. In a variant embodiment, one of the second side surfaces 126 of the light guide plate 102 in the second direction D2 maybe perpendicular to the bottom surface 110, and the other second side surface 126 may have the second inclined surface 128. In addition, the second angle θ₂ is between the second inclined surface 128 and the bottom surface 110, and the second angle θ₂ is an acute angle.

Please refer to FIG. 7 and FIG. 8. The optical path of the light L shown in FIG. 7 may be the same as the first embodiment and FIG. 2 and will not be redundantly described here. As shown in FIG. 8, a light L emitted by the light source 104 enters into the light guide plate 102 through the light incident surface 112 and travels in the light guide plate 102. A portion of the light L enters into the light guide plate 102 through the light incident surface 112, the portion of the light L then travels to the second side surface 126 and exits the light guide plate 102 through the second side surface 126. The light L exiting the light guide plate 102 through the second side surface 126 is then transmitted to the reflecting surface 134 of the second portion 130 of the plastic frame 106. Next, the light L is reflected by the reflecting surface 134 to the second side surface 126, and the light L is then refracted through the second side surface 126 into the light guide plate 102 again. In addition, a portion of the light L enters into the light guide plate 102 through the second side surface 126, the portion of the light L is then directed to the light emitting surface 108 by the micro structures 118 of the bottom surface 110, and the portion of the light L then exits the light guide plate 102 through the light emitting surface 108. It is noteworthy that the second angle θ₂ is between the second side surface 126 and the bottom surface 110 of the light guide plate 102 of this embodiment, and the second angle θ₂ is an acute angle. Therefore in this embodiment, the light L reflected by the reflecting surface 134 is refracted through the second side surface 126 into the light guide plate 102, and the position where the light L strikes the bottom surface 110 of the light guide plate 102 is closer to the second side surface 126 comparing to the light guide plate 102 having the bottom surface 110 being perpendicular to the second side surface 126. As a result, the uniformity of the light provided by the backlight module 200 can be enhanced, and the micro structures 118 disposed adjoining to the second side surface 126 can be utilized.

In this embodiment, the second angle θ₂ of the light guide plate 102 substantially satisfies the formula (4):

$$2 {sin}^{- 1} ( \frac{{n}_{1}}{{n}_{2}} ) - α < {θ}_{2} < \frac{π}{2} \qquad ( 4 )$$

where n₁ represents a refractive index of a medium outside the light guide plate 102, n₂ represents a refractive index of the light guide plate 102, and a is an estimated value of the deviation caused during the fabrication or the assembling of the backlight module 100. α may be 5° in this embodiment, but not limited thereto. The derivation of the formula (4) may be the same as the formula (3) in the first embodiment and FIG. 4 and will not be redundantly described here. According to the formula (4), the second angle θ₂ of the light guide plate 102 can be prevented from being too small to cause the light L to be refracted through the bottom surface 110 to the outside of the light guide plate 102, the additional loss the light L can also be prevented, and the utilization of the light L in the backlight module 200 can be enhanced. In another aspect, the result of the simulation of the backlight module 200 of this embodiment may be the same as the first embodiment and FIG. 5. In this embodiment, the light L reflected by the plastic frame 106 is refracted through the second side surface 126 into the light guide plate 102, and the position where the light L strikes the bottom surface 110 becomes closer to the second side surface 126 as the second angle θ₂ becomes smaller. Therefore, the uniformity of the light provided by the backlight module 200 of this embodiment can be enhanced, and the micro structures 118 disposed adjoining to the second side surface 126 can be utilized. What's more, the first angle θ₁ may be less than or equal to the second angle θ₂ in this embodiment, and the first angle θ₁ is preferably less than the second angle θ₂, but not limited thereto. The first angle θ₁ and the second angle θ₂ may be the same or different according to the requirements. Moreover, two second angles θ₂ may also be the same or different according to the requirements.

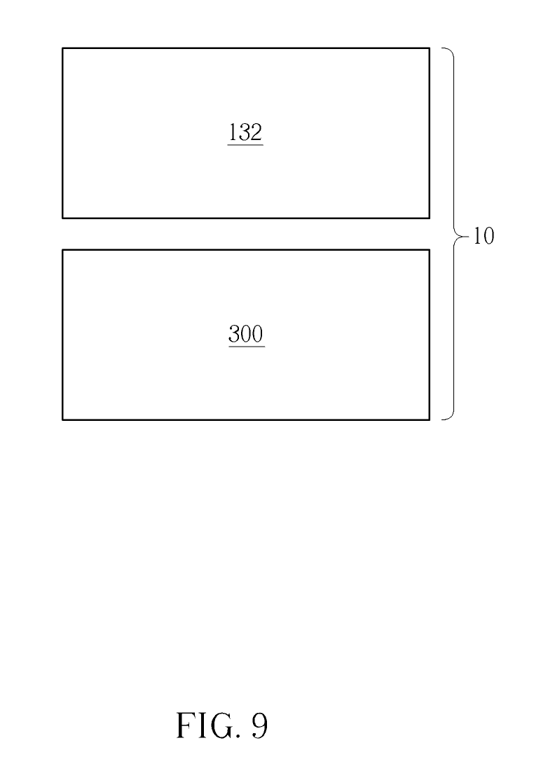

Please refer to FIG. 9. FIG. 9 is a schematic diagram illustrating a cross-sectional view of a liquid crystal display according to an embodiment of the present invention. As shown in FIG. 9, a liquid crystal display 10 includes a backlight module 300 and a liquid crystal display panel 132, and the liquid crystal display panel 132 is disposed on the light emitting surface 108 of the light guide plate 102. The backlight module 300 of this embodiment may be any backlight module of the aforementioned embodiments. In this embodiment, the liquid crystal display panel 132 is a non-self-luminous display panel, but not limited thereto. The liquid crystal display panel 132 may be other types of the liquid crystal display panels. The liquid crystal display panel 132 of this embodiment may also be a flat liquid crystal display panel or a curved liquid crystal display panel.

To summarize the above descriptions, in the backlight module and the liquid crystal display provided by the present invention, the light guide plate includes the first side surface having the first inclined surface in the first direction, and the first angle is between the first inclined surface and the bottom surface. In the present invention, the light reflected by the plastic frame is refracted through the first side surface to the bottom surface of the light guide plate, and the position where the light strikes the bottom surface is closer to the first side surface comparing to the light guide plate having the side surface being perpendicular to the bottom surface. In addition, the light guide plate of the present invention may selectively have the second side surface in the second direction. The second side surface has the second inclined surface, and the second angle is between the second inclined surface and the bottom surface. As a result, the uniformity of the light provided by the backlight module and the uniformity of the light displayed by the liquid crystal display can be enhanced, and the micro structures disposed adjoining to the first side surface or the second side surface can also be utilized. Furthermore, the issue of the poor uniformity in the peripheral region of the conventional backlight module can be solved, and the poor display quality in the peripheral region of the liquid crystal display can also be solved.

Those skilled in the art will readily observe that numerous modifications and alterations of the device and method may be made while retaining the teachings of the invention. Accordingly, the above disclosure should be construed as limited only by the metes and bounds of the appended claims.

1. A backlight module, comprising:
a light guide plate, comprising:
a light emitting surface;
a bottom surface disposed opposite to the light emitting surface;
a light incident surface disposed between the light emitting surface and the bottom surface and respectively connected to the light emitting surface and the bottom surface; and
a first side surface disposed opposite to the light incident surface and respectively connected to the light emitting surface and the bottom surface, wherein the first side surface consists of a first inclined surface, a first angle is between the first inclined surface and the bottom surface, and the first angle is an acute angle;
a light source facing the light incident surface for emitting a light, wherein the light enters into the light guide plate through the light incident surface; and
a plastic frame comprising a first portion facing the first side surface, wherein a portion of the light exits the light guide plate through the first side surface, and the portion of the light is reflected back to the first side surface by the first portion and is refracted through the first side surface to the bottom surface.

2. The backlight module according to claim 1, wherein the light guide plate further comprises a plurality of micro structures disposed on the bottom surface.

3. The backlight module according to claim 1, further comprising a reflector disposed under the bottom surface of the light guide plate.

4. The backlight module according to claim 1, wherein the first portion of the plastic frame has a reflecting surface to reflect the light.

5. The backlight module according to claim 1, wherein the first angle satisfies the following condition:
$$2 {sin}^{- 1} ( \frac{{n}_{1}}{{n}_{2}} ) - 5 ° < {θ}_{1} < \frac{π}{2}$$
wherein θ₁ represents the first angle, n₁ represents a refractive index of a medium outside the light guide plate, and n₂ represents a refractive index of the light guide plate.

6. The backlight module according to claim 1, wherein the light guide plate further comprises a second side surface disposed between the light incident surface and the first side surface and respectively connected to the light emitting surface and the bottom surface, the second side surface has a second inclined surface, a second angle is between the second inclined surface and the bottom surface, and the second angle is an acute angle.

7. The backlight module according to claim 6, wherein the plastic frame further comprises a second portion facing the second side surface, a portion of the light exits the light guide plate through the second side surface, and the portion of the light is reflected back to the second side surface by the second portion and is refracted through the second side surface to the bottom surface.

8. The backlight module according to claim 7, wherein the second portion of the plastic frame has a reflecting surface to reflect the light.

9. The backlight module according to claim 6, wherein the second angle satisfies the following condition:
$$2 {sin}^{- 1} ( \frac{{n}_{1}}{{n}_{2}} ) - 5 ° < {θ}_{2} < \frac{π}{2}$$
wherein θ₂ represents the second angle, n₁ represents a refractive index of a medium outside the light guide plate, and n₂ represents a refractive index of the light guide plate.

10. The backlight module according to claim 6, wherein the first angle is less than or equal to the second angle.

11. A liquid crystal display, comprising:
the backlight module according to claim 1; and
a liquid crystal display panel disposed on the light emitting surface of the light guide plate.
